(19) United States
(12) Patent Application Publication
(10) Pub. No.: US 2017/0018804 A1
(43) Pub. Date: Jan. 19, 2017

(54) ELECTROLYTE AND MAGNESIUM SECONDARY BATTERY

(71) Applicants: HONDA MOTOR CO., LTD., Tokyo (JP); SAITAMA PREFECTURE, Saitama (JP)

(72) Inventors: Hiroshi Ogasa, Wako-shi (JP); Toru Sukigara, Wako-shi (JP); Hideki Kurihara, Kawaguchi-shi (JP); Masashi Inamoto, Kawaguchi-shi (JP)

(73) Assignees: HONDA MOTOR CO., LTD., Tokyo (JP); SAITAMA PREFECTURE, Saitama (JP)

(21) Appl. No.: 15/208,136

(22) Filed: Jul. 12, 2016

(30) Foreign Application Priority Data
Jul. 13, 2015 (JP) 2015-139770

(51) Int. Cl. H01M 10/0567; H01M 10/0569; H01M 4/38; H01M 4/131; H01M 4/48; H01M 4/66; H01M 10/054; H01M 10/0568

(52) U.S. Cl. CPC H01M 10/0567; H01M 10/054; H01M 10/0569; H01M 10/0568; H01M 4/131; H01M 4/483; H01M 4/661; H01M 4/381; H01M 2004/028

(57) ABSTRACT

To provide an electrolyte and a magnesium secondary battery that can embody a magnesium secondary battery having room-temperature operability and satisfactory cyclability. An electrolyte 13 including an organic solvent, magnesium salt and cyclic acid anhydride is provided. Cyclic acid anhydride is preferably contained at a concentration at least equimolar to magnesium salt, and is further preferably contained at a molar concentration 1.0 to 3.0 times that of magnesium salt. Further, a magnesium secondary battery 1 including these electrolyte 13 and a negative electrode 12 containing magnesium or magnesium alloy is provided.

This application is based on and claims the benefit of priority from Japanese Patent Application No. 2015-139770, filed on 13 Jul. 2015, the content of which is incorporated herein by reference.

### BACKGROUND OF THE INVENTION

Field of the Invention

The present invention relates to an electrolyte and a magnesium secondary battery including the electrolyte.

Related Art

Conventionally, ion secondary batteries are utilized in a wide range of fields, because of the capability of storing electricity through charging, and the highly convenient reusability. For example, lithium ion secondary batteries are capable of high voltage, capacity and energy density, and are utilized in various fields such as, in particular, cellular phones, notebook computers, batteries for power-generating facilities such as wind/solar power plants, electric vehicles, uninterruptible power supply systems, and home batteries.

In the meantime, magnesium ion secondary batteries (hereinafter referred to as “magnesium secondary battery”) have a theoretical capacity higher than that of lithium ion secondary batteries. Further, a magnesium secondary battery can use magnesium that is relatively inexpensive and abundant, unlike lithium being a rare (less abundant) metal, and is therefore expected to reduce the cost. Further, magnesium has a melting point higher than that of lithium, and is therefore superior to lithium, in terms of safety; therefore, a magnesium secondary battery is expected to come into practical use.

However, divalent magnesium ions are considerably slower in reacting at the electrode compared to univalent lithium ions, and have a problem of being difficult to diffuse due to strong interactions. Further, there are still challenges to developing a stable and safe magnesium electrolyte, in which magnesium metal can be repeatedly dissolved and deposited.

Against such a background, an electrolyte has been disclosed (for example, refer to Non-patent Document 1), in which magnesium salt such as Mg(TFSA)₂ or Mg(TFSI)₂ is combined with THF (tetrahydrofuran) or a high-boiling ether type solvent such as diglyme, triglyme or tetraglyme.

Non-patent Document 1: Yoshiharu UCHIMOTO and throe others, “Success in Developing Secondary Battery of High Energy Density, High Safety, and Low Cost—from lithium toward magnesium metal—”, [online], Jul. 7, 2014 [search conducted on May 22, 2015], the Internet <URL: http://www-kyoto-u.ac.jp/ja/research/research_results/2014/documents/140711_1/0l.pdf>

### SUMMARY OF THE INVENTION

However, under the present situation, room-temperature operability and satisfactory cyclability for practical use have not yet been achieved in the electrolyte having such conventional constitution.

The present invention has been made in light of the aforementioned problems, and an object of the present invention is to provide an electrolyte and a magnesium secondary battery, which can embody a magnesium secondary battery having room-temperature operability and satisfactory cyclability.

(1) In order to achieve the aforementioned object, a first aspect of the present invention provides an electrolyte (for example, an electrolyte 13 to be described later) including an organic solvent, magnesium salt and cyclic acid anhydride.

According to the first aspect of the present invention, the electrolyte contains cyclic anhydride, magnesium salt, and an organic solvent. It is thought that cyclic acid anhydride and magnesium salt dissolve into the organic solvent, and form a complex. Further, it is thought, that the complex attaches to the surface of the negative electrode after charging/discharging, and a coating derived from magnesium salt (solid electrolyte interphase, hereinafter referred to as SEI) is formed thereon. As a result, according to the present invention, since the SEI enables a reversible oxidation-reduction reaction to occur, room-temperature operability and satisfactory cyclability are achieved.

(2) In a second aspect of the present invention according to the first aspect, the cyclic acid anhydride is preferably contained at a concentration at least equimolar to the magnesium salt.

According to the second aspect of the present invention, a satisfactory SEI can be formed on the negative electrode, and a sufficiently reversible oxidation-reduction reaction is enabled; as a result, room-temperature operability and satisfactory cyclability are achieved.

(3) In a third aspect of the present invention according to the first aspect, the cyclic acid anhydride is preferably contained at a molar concentration 1.0 to 3.0 times that of the magnesium salt.

According to the third aspect of the present invention, an optimal SEI can be formed on the negative electrode, and a sufficiently reversible oxidation-redaction reaction is enabled; as a result, room-temperature operability and satisfactory cyclability are achieved.

(4) A fourth aspect of the present invention provides s magnesium secondary battery including: a negative electrode having magnesium or magnesium alloy; and the electrolyte according to any one of the first to third aspects.

According to the fourth aspect of the present invention, it is possible to realize a magnesium secondary battery having room-temperature operability and satisfactory cyclability.

According to the present invention, it is possible to provide an electrolyte and a magnesium secondary battery, which can embody a magnesium secondary battery having room-temperature operability and satisfactory cyclability.

### BRIEF DESCRIPTION OF THE DRAWINGS

FIG. 1 is a schematic diagram showing a configuration of a magnesium secondary battery according to an embodiment of the present invention;

FIG. 2A is a schematic diagram showing a configuration of SEI formed on the surface of a negative electrode after discharging the magnesium secondary battery according to the embodiment of the present invention;

FIG. 2B is a schematic diagram showing a configuration of SEI formed on the surface of the negative electrode after charging the magnesium secondary battery according to the embodiment of the present invention;

FIG. 3 is a diagram showing a CV curve of Comparative Example 1;

FIG. 4 is a diagram showing a CV curve of Comparative Example 2;

FIG. 5 is a diagram showing a CV curve of Comparative Example 3;

FIG. 6 is a diagram showing a CV curve of Comparative Example 4;

FIG. 7 is a diagram showing a CV curve of Example 1;

FIG. 8 is a diagram showing a CV curve of Example 2;

FIG. 9 is a diagram showing a CV curve of Example 3;

FIG. 10 is a diagram showing a CV curve of Example 4;

FIG. 11 is a diagram showing a CV curve of Example 5;

FIG. 12 is a diagram showing a CV curve of Example 6;

FIG. 13 is a diagram showing a CV curve of Example 7;

FIG. 14 is a diagram showing a CV curve of Example 8;

FIG. 15A is a diagram showing a charging/discharging curve of Example 7;

FIG. 15B is a diagram showing a charging/discharging curve of Example 7;

FIG. 16A is a diagram showing XPS spectrum of fluorine after discharging of Example 8;

FIG. 16B is a diagram showing XPS spectrum of fluorine after discharging/charging of Example 8;

FIG. 17A is a diagram showing XPS spectrum of sulfur after discharging of Example 8;

FIG. 17B is a diagram showing XPS spectrum of sulfur after discharging/charging of Example 8;

FIG. 18A is a diagram showing XPS spectrum of carbon after discharging of Example 8;

FIG. 18B is a diagram showing XPS spectrum of carbon after discharging/charging of Example 8;

FIG. ISA is a diagram showing XPS spectrum of magnesium after discharging of Example 8; and

FIG. 19B is a diagram showing XPS spectrum of magnesium after discharging/charging of Example 8.

### DETAILED DESCRIPTION OF THE INVENTION

An embodiment of the present invention is hereinafter described with reference to the drawings.

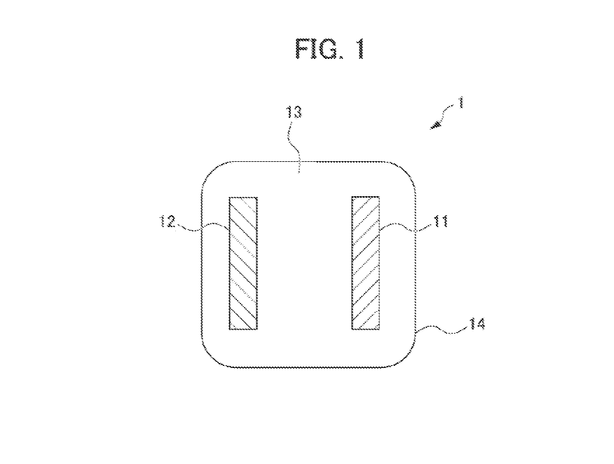

FIG. 1 is a schematic diagram showing a configuration of a magnesium secondary battery according to the present embodiment. As shown in FIG. 1, a magnesium secondary battery 1 includes a positive electrode 11, a negative electrode 12, an electrolyte 13, and a container 14.

In the positive electrode 11, a positive electrode collector (not shown) retains a positive electrode active material (not shown). The positive electrode collector has a function to donate electrons to the positive electrode active material at the time of discharging. As a material for the positive electrode collector, nickel, iron, stainless steel, titanium, aluminum, or the like is preferably used, since they are inexpensive and have relatively superior corrosion resistance. A material used for the positive electrode active material is not limited in particular, as long as the material is capable of insertion and desorption of magnesium ions; however, MgFoSiO₄, MgMn₂O₄, V₂O₅ or the like is preferably used. As an example of a specific configuration of the positive electrode 11, for example, V₂O₅ is applied onto stainless steel.

Magnesium or magnesium alloy is preferably used for the negative electrode 12. An SEI derived from magnesium salt of the electrolyte 13 is formed on the surface of the negative electrode 12.

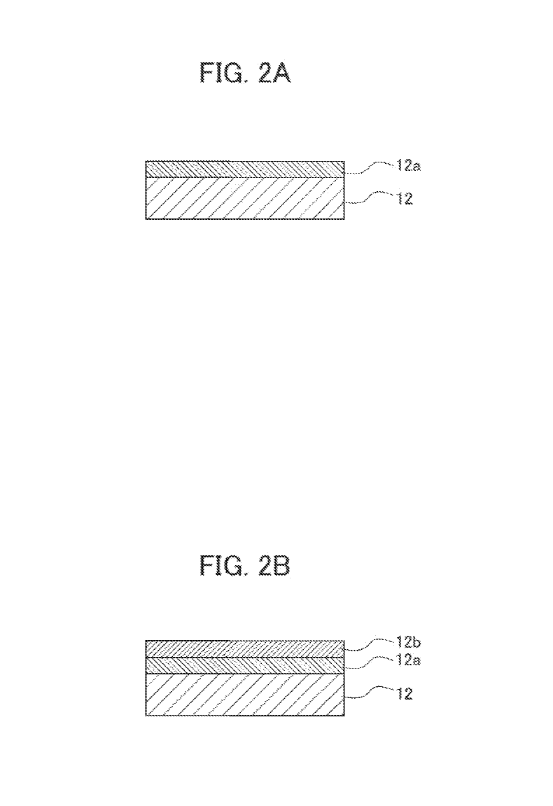

FIG. 2A is a diagram showing an SEI formed on the surface of the negative electrode after discharging the magnesium secondary battery; and FIG. 2B is a diagram showing another SEI formed on the surface of the negative electrode after charging after discharging the magnesium secondary battery.

As shown in FIG. 2A, an SEI 12a is formed on the surface of the negative electrode 12 after discharging. The SEI 12a is a passive-state coating without electron conductivity. Further, as shown in FIG. 2B, after charging after discharging, an SEI 12b is further formed on the SEI 12a formed on the surface of the negative electrode 12, constituting a two-layer structure. It is considered that the SEI 12b is a coating capable of occluding and releasing magnesium ions.

The electrolyte 13 is retained by way of a separator (not shown), and produces ion conductivity between the positive electrode 11 and the negative electrode 12. The electrolyte 13 contains magnesium ions. At the time of discharging, magnesium ions cause a reduction reaction at the positive electrode 11 (for example, a reaction of Formula (a) to be described later), and an oxidation reaction at the negative electrode 12 (for example, a reaction of Formula (b) to be described later). At the time of charging, magnesium ions cause an oxidation reaction at the positive electrode 11 (for example, a reaction of Formula (c) to be described later), and a reduction reaction at the negative electrode 12 (for example, a reaction of Formula (d) to be described later). Such oxidation-reduction reactions allow the magnesium secondary battery to be charged and discharged.

[Chemical Formula 1]

V₂O₅+Mg²⁺2e⁻→MgV₂O₅ Formula (a)

Mg→Mg²⁺+2e⁻ Formula (b)

MgV₂O₅→V₂O₅+Mg²⁺+2e⁻ Formula (c)

Mg²⁺+2e⁻→Mg Formula (d)

The positive electrode 11, the negative electrode 12 and the electrolyte 13 are encapsulated in the container 14. As long as a material for the container 14 is electrolyte-tight and anticorrosive, the material is not limited in particular; however, for example, a material is preferably used, which is formed by pressing a metal plate made of iron or the like, and forming a plated layer of anticorrosive nickel or the like on the entire internal and external surfaces.

The electrolyte 13 according to the present embodiment consists of an organic solvent as a primary solvent, magnesium salt, and cyclic acid anhydride as an additive. Cyclic acid anhydride is preferably added in an amount equal to or greater than magnesium salt added. This allows for forming a satisfactory SEI on the surface of the negative electrode, and improving the charging/discharging cyclability.

Cyclic acid anhydride used in the present embodiment is a material formed through intramolecular dehydrogenative condensation of dicarhoxylic acid, and consists of two basic skeletons of: succinic anhydride having a five-membered ring structure (hereinafter referred to as “SAA”), and glutaric anhydride having a six-membered ring structure (hereinafter referred to as “GAA”). Note that cyclic acid anhydride used in the present embodiment may be a derivative of any one of SAA or GAA, to which a functional group is coupled.

If cyclic acid anhydride is added in an amount below a concentration equimolar to magnesium salt, when an oxidation-reduction cycle is repeated, the reaction would be deteriorated. Therefore, cyclic acid anhydride should be added in an amount, at a concentration at least equimolar to magnesium salt. Further, cyclic acid anhydride should be added in an amount with the upper limit, which allows cyclic acid anhydride to be dissolved into the electrolyte, and which provides the electrolyte with viscosity that allows magnesium ions to move. Therefore, SAA is added in a preferred amount at a molar concentration 1.0 to 3.0 times that of magnesium salt; and GAA is added in a preferred amount at a molar concentration 1.0 to 4.0 times that of magnesium salt.

As magnesium salt used in the present embodiment, magnesium bis(trifluoromethanesulfonyl)imide [Mg(TFSI)₂], or magnesium bis (trifluoromethanesulfonylamide) [Mg(TFSA)₂] is used.

An organic solvent as a primary solvent used in the present embodiment is not limited in particular; however, high-boiling symmetrical glycol diether, such as diglyme (diethylene glycol dimethyl ether), triglyme (trienthylene glycol dimethyl ether), or tetraglyme (tetraethylene glycol dimethyl ether), is preferably used. As a result, it is thought that cyclic acid anhydride and magnesium salt dissolve into the primary solvent to form an electrolyte, forming magnesium ions and a complex in the electrolyte.

It is thought that the complex covers the surface of the negative electrode, and forms an SEI. That is to say, it is thought that, after discharging, the complex covers the surface of the negative electrode with magnesium ions desorbed, and forms an SEI.

Although the process of forming an SEI is not exactly clear, it is thought that, after discharging, the magnesium surface of the negative electrode is firstly covered with a component that is highly charged or chemisorptive in relation to magnesium, and is secondly covered with another component that is less charged or chemisorptive in relation to magnesium.

More specifically, firstly, at the time of discharging, an SEI containing, for example, fluorocarbon derived from magnesium salt, is formed on the surface of the negative electrode; and secondly, at the time of charging after discharging, an SEI containing, for example, sulfate derived from magnesium salt, is further formed on the upper layer thereof. The SEI, which is formed at the time of charging, is a coating capable of occluding magnesium ions; and the SEI disappears at the time of discharging. Therefore, it is considered that the SEI formed at the rime of charging occludes magnesium ions at the time of charging, and releases magnesium ions at the time of discharging, thereby enabling a reversible oxidation-reduction reaction to occur.

Next, a method for manufacturing the magnesium secondary battery 1 is described.

First of all, the electrolyte 13 is prepared. The electrolyte 13 is prepared inside a gloved box under an argon atmosphere. An organic solvent as a primary solvent, magnesium salt, and cyclic acid anhydride as an additive are measured in a prescribed amount, blended at the same time, and agitated, and dissolved by using a magnetic stirrer. The solution temperature may be around 25° C. to 35° C. so as to improve the solubility.

The positive electrode 11 is prepared by causing the positive electrode active material to come in contact with the positive electrode collector. The magnesium secondary battery 1 can be prepared by using the electrolyte 13, the positive electrode 11 and the negative electrode 12 obtained in this manner.

As a result, the present embodiment achieves the following effects.

The electrolyte in the present embodiment contains cyclic anhydride, magnesium salt, and an organic solvent. Cyclic acid anhydride is contained at a molar concentration at least 1.0 times that of magnesium salt, and is preferably contained at a molar concentration 1.0 to 3.0 times that of magnesium salt. It is thought that cyclic acid anhydride and magnesium salt dissolve into the organic solvent, and form a complex. It is thought that the complex attaches to the surface of the negative electrode after charging/discharging, and forms an SEI derived from magnesium salt. Since the SEI enables a reversible oxidation-reduction reaction to occur, room-temperature operability and satisfactory cyclability are achieved. Therefore, according to the electrolyte of the present embodiment, it is possible to provide a magnesium secondary battery having room-temperature operability and satisfactory cyclability.

Note that the present invention is not limited to the embodiments described above, and the present invention includes alterations, improvements, etc. within the scope that can achieve the object of the present, invention.

### EXAMPLES

Next, Examples of the present invention are described; however, the present invention is not limited to the Examples.

### Examples 1 to 8 and Comparative Examples 1 to 4

The electrolyte was prepared inside a gloved box by dissolving cyclic acid anhydride and magnesium salt into an organic solvent, at each predetermined concentration shown in Table 1. SAA or GAA was used for cyclic acid anhydride; Mg(TFSI)₂ was used for magnesium salt; and triglyme was used for an other type solvent.

TABLE 1

| | | EX- | EX- | EX- | EX- | EX- | EX- | EX- | EX- | COM- | COM- | COM- | COM- |
|---|---|---|---|---|---|---|---|---|---|---|---|---|---|
| | | AM- | AM- | AM- | AM- | AM- | AM- | AM- | AM- | PARATIVE | PARATIVE | PARATIVE | PARATIVE |
| | | PLE | PLE | PLE | PLE | PLE | PLE | PLE | PLE | EXAM- | EXAM- | EXAM- | EXAM- |
| | | 1 | 2 | 3 | 4 | 5 | 6 | 7 | 8 | PLE 1 | PLE 2 | PLE 3 | PLE 4 |
| Mg SALT(mol/l) | | 0.5 | 0.5 | 0.5 | 0.5 | 0.5 | 0.75 | 0.25 | 0.25 | 0.5 | 0.5 | 0.5 | 0.5 |
| CYCLIC | SAA | 0.5 | 0.6 | 1.0 | 1.2 | 1.5 | 0 | 0 | 0 | 0 | 1.0 | 0.1 | 0.4 |
| ACID | GAA | 0 | 0 | 0 | 0 | 0 | 1.0 | 0.5 | 1.0 | 0 | 0 | 0 | 0 |
| ANHYDRIDE | | | | | | | | | | | | | |
| (mol/l) | | | | | | | | | | | | | |

| | | | | | | | | | | | | |
|---|---|---|---|---|---|---|---|---|---|---|---|---|
| CYCLIC ACID | 1.0 | 1.2 | 2.0 | 2.4 | 3.0 | 1.33 | 2.0 | 4.0 | 0 | 2.0 | 0.2 | 0.8 |
| ANHYDRIDE/Mg | | | | | | | | | | | | |
| SALT | | | | | | | | | | | | |

### Cyclic Voltammetry

Cyclic voltammetry (hereinafter referred to as “CV method”) was performed on the respective batteries using the electrolytes of Examples 1 to 8 and Comparative Examples 1 to 4. A three-electrode method was employed as the CV method, which was performed based on the following conditions.

### CV Method Conditions

Positive electrode: V₂O₅ was used as a positive electrode active material to be applied on an BUS foil (except for Comparative Example 2)

Negative electrode: Mg metal

Reference electrode: Mg metal

Sweep rate: 1 mmV/second

Sweep range: 0.5 to 2.5 V (vsMg²⁺/Mg)

Number of cycles: 3 to 20 cycles

Measurement atmosphere: 25° C. in the atmosphere

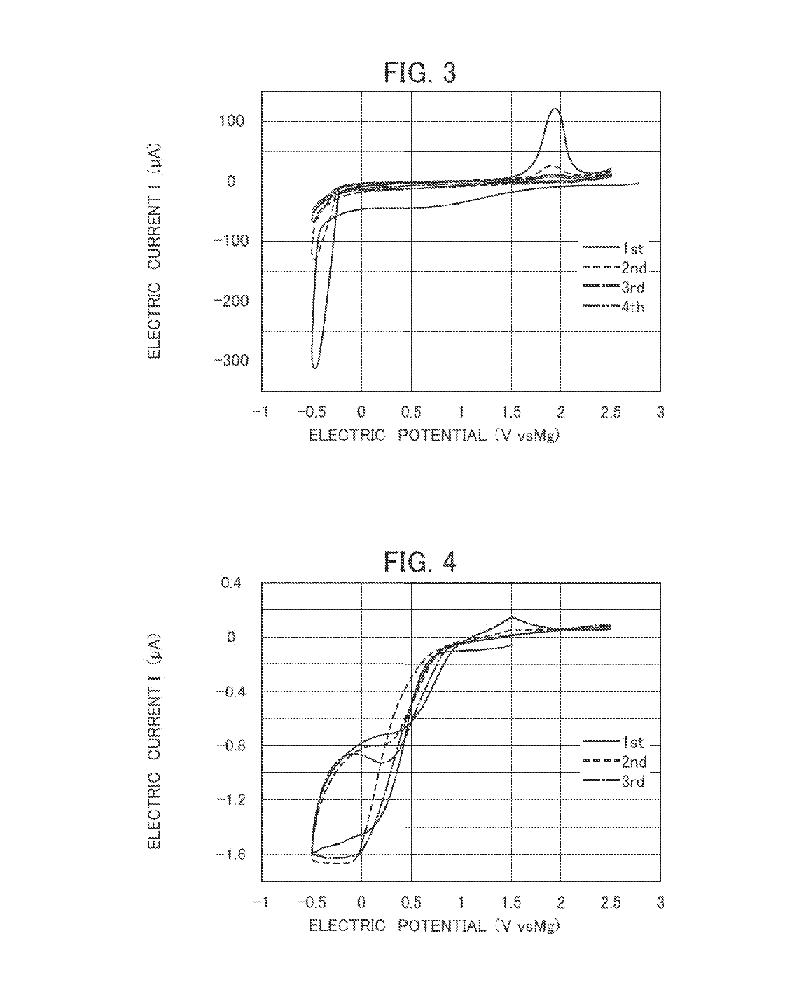

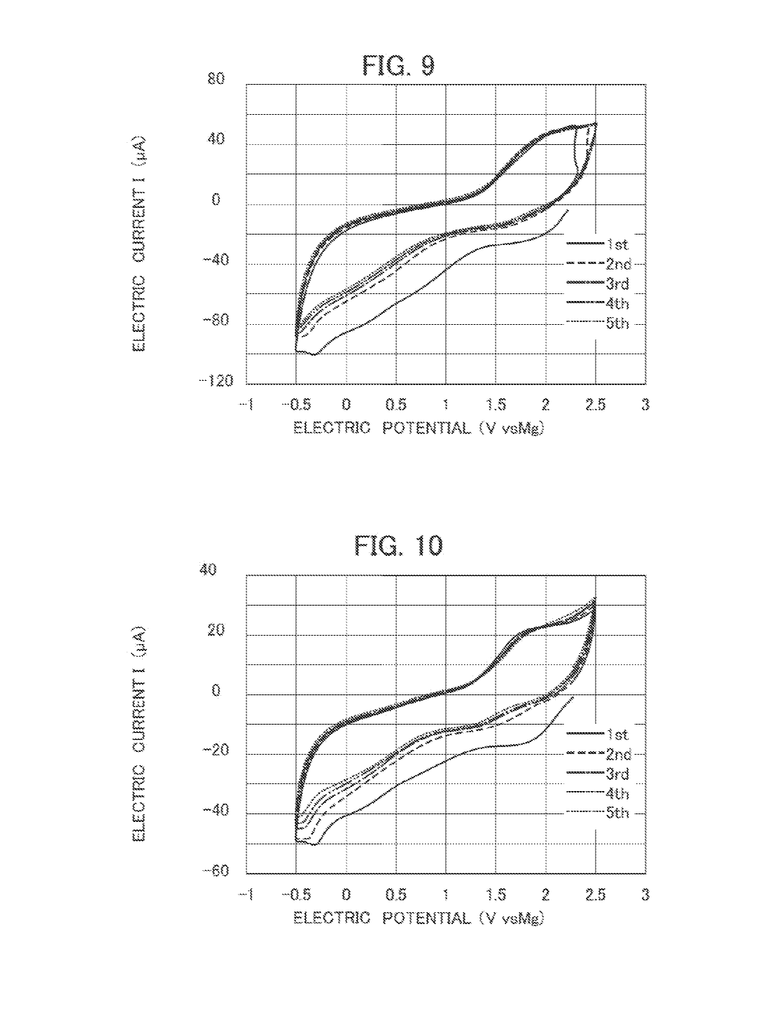

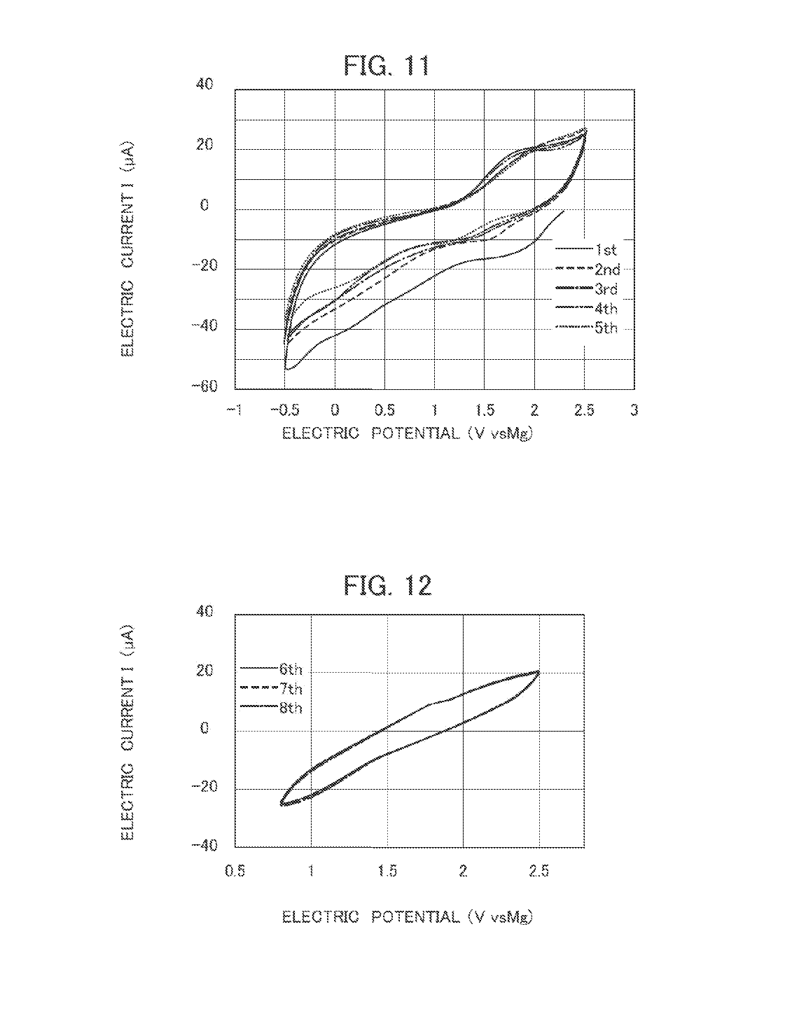

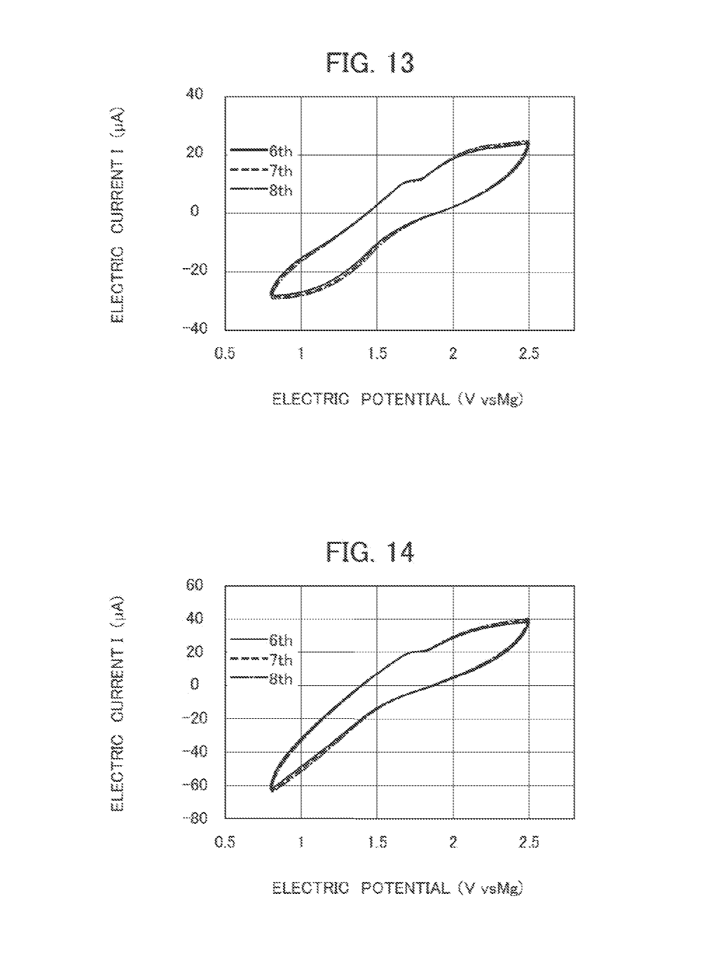

FIGS. 3 to 14 show cyclic voltammogram (hereinafter referred to as “CV curve”) obtained by way of the CV method. The vertical axis represents electric current. (μA); and the horizontal axis represents electric potential (V) applied.

FIG. 3 shows a CV curve obtained by the electrolyte of Comparative Example 1. As shown in FIG. 3, a reaction peak indicating overcurrent appeared at both of the reducing side and the oxidizing side during the first cycle; the reaction peak decreased from the second cycle onward; and the reaction peak disappeared during the third cycle. From the result of FIG. 3, it was confirmed that a reversible oxidation-reduction reaction would not occur if cyclic acid anhydride such as SAA was not added to the electrolyte.

FIG. 4 shows a CV curve obtained by the electrolyte of Comparative Example 2. In Comparative Example 2, SAA at a molar concentration 2.0 times that of magnesium salt was added to the electrolyte, but the positive electrode had only an SUS foil without, any active material applied thereto. As shown in FIG. 4, a peak indicating overcurrent appeared only at the reducing side, and an oxidation peak did not appear. Therefore, it became clear that the peaks that appeared in FIGS. 3 to 14 were caused by an oxidation-reduction reaction between the positive electrode and the negative electrode.

From the result of FIGS. 3 and 4, it was confirmed that the following reversible oxidation-reduction reaction was caused by adding cyclic acid anhydride to the electrolyte.

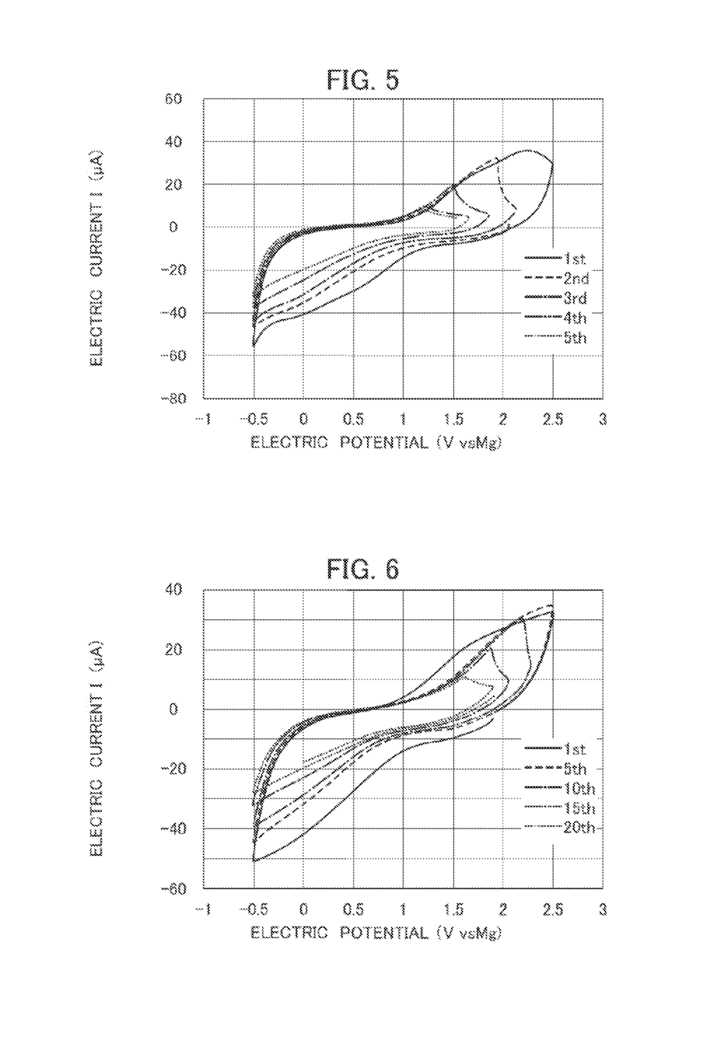

FIGS. 5 and 6 show CV curves obtained by the electrolytes of Comparative Examples 3 and 4, respectively. As shown in Table 1, in the electrolytes, cyclic acid anhydride was added in an amount (0.2 or 0.8) below a molar concentration 1.0 times that of magnesium salt. As shown in FIGS. 5 and 6, from the second cycle onward, the reaction peak gradually decreased at both of the reducing side and the oxidizing side.

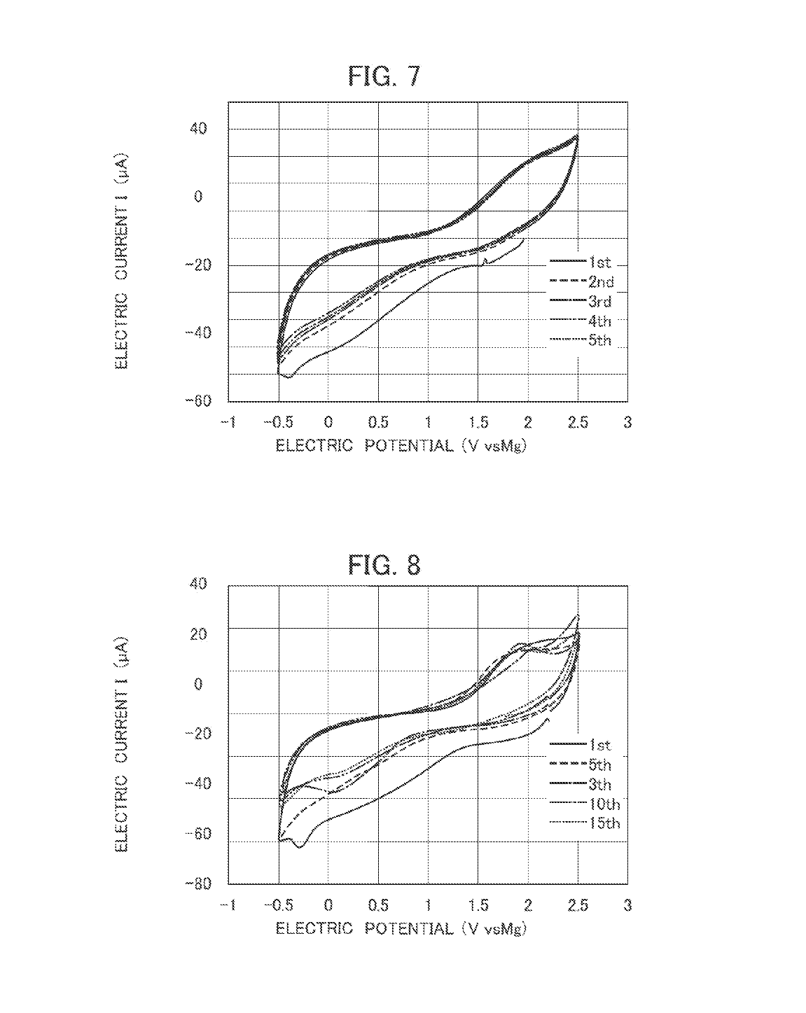

FIGS. 7 to 14 show CV curves obtained by the electrolytes of Examples 1 to 8, respectively. As shown in Table 1, in the electrolytes, cyclic acid, anhydride was added in an amount (1.0, 1.2, 2.0, 2.4, 3.0, 1.33, 2.0, or 4.0) at a molar concentration at least 1.0 times that of magnesium salt.

As shown in FIGS. 7 to 14, from the second cycle onward, the reaction peak changed little at both of the reducing side and the oxidizing side.

As a result of comparing Examples 1 to 8 with Comparative Examples 1, 3 and 4, was confirmed that a sufficiently reversible oxidation-reduction reaction was not achieved in Comparative Examples 1, 3 and 4, in which SAA or GAA was added in an amount below a molar concentration 1.0 times that of magnesium salt; whereas a sufficiently reversible oxidation-reduction reaction was achieved at room temperature in Examples 1 to 8, in which SAA or GAA was added in an amount at a molar concentration at least 1.0 times that of magnesium salt.

### Charging/Discharging Test

A charging/discharging test was performed on the battery using the electrolyte of Example 7. The charging/discharging test was performed based on the following conditions.

### Charging/Discharging Test Conditions

Positive electrode: V₂O₅

Negative electrode; AZ31 (magnesium alloy)

Charging/discharging condition: 2 μA, 7.5 h

Number of cycles: 12 cycles

Measurement atmosphere: 25° C. in the atmosphere

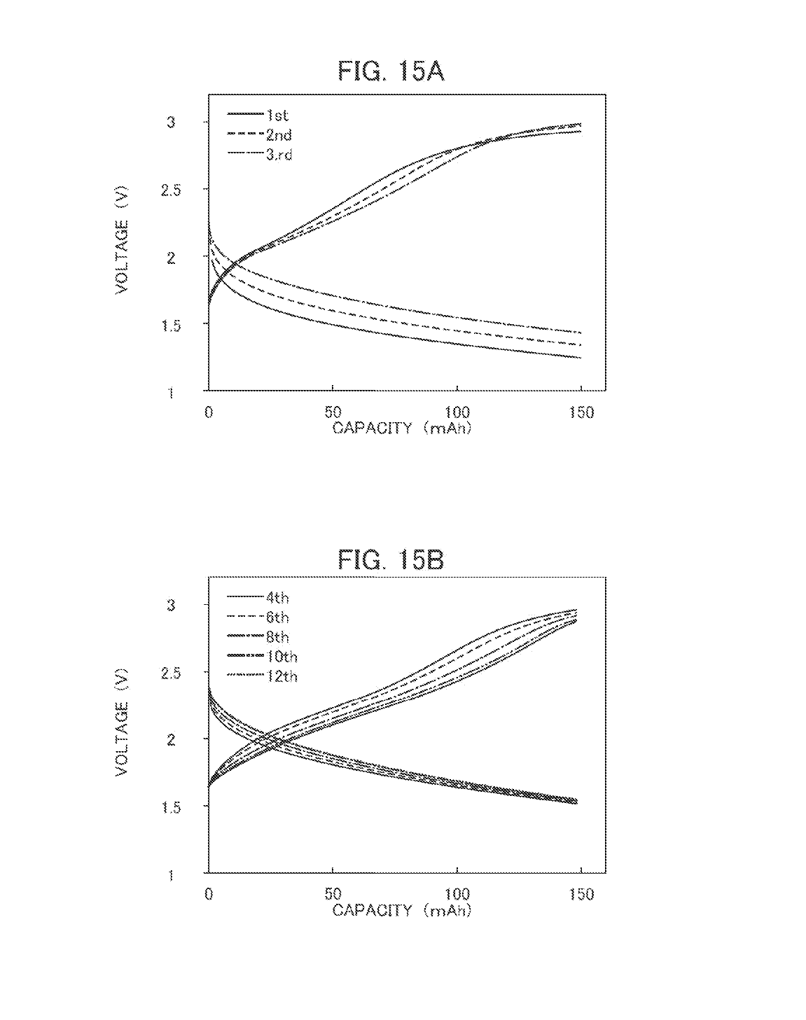

FIGS. 15A and 15B each show a charging/discharging curve obtained by the charging/discharging test. The vertical axis represents voltage (V); and the horizontal axis represents capacity per 1 g of V₂O₅ (mAh/g).

As shown in FIGS. 15A and 15B, in Example 7, the voltage slightly increased as the negative electrode was activated during the first to third cycles; but the charging/discharging curves stably appeared relatively closer to each other, from the fourth cycle onward. From the result above, it was confirmed that satisfactory cyclability was obtained at room temperature, in the cases in which the electrolyte of the present embodiment was used for the magnesium secondary battery.

### Surface Elemental Composition Analysis

A surface elemental composition analysis based on X-ray photoelectron spectroscopy (XPS) was performed on the battery using the electrolyte of Example 8. The XPS measurement was performed based on the following conditions.

### XPS Measurement Conditions

Measurement equipment: AXIS-ULTRA DLD manufactured by KRATOS Ltd.

X-ray source: MONO (AL)

Emission: 10 mA

Anode HT: 15 KV

Measurement range: 1400 eV−0 eV

Depth: Ar gas

A sample for XPS analysis was prepared by way of the following method. An electrolyte similar to Example 8 was used; an electrode coated with V₂O₅ was used for a working electrode; Mg metal was used for a counter electrode; and Mg metal was used for a reference electrode; thereby making a tripolar cell. A surface analysis was conducted by taking the Mg electrode out, in the state of having charged after discharging, and in the state of having discharged after redaction/discharge by making a new cell.

The XPS analysis was conducted by way of the following method. A sample was set into a device, in the state of not being exposed to the atmosphere; depth milling (or surface milling, hereinafter referred to as “milling”) was performed by using Ar gas after measurement; and an analysis and milling were repeated at a constant interval. The aforementioned method revealed ingredients of the composition in a certain depth direction from the surface of the Mg negative electrode.

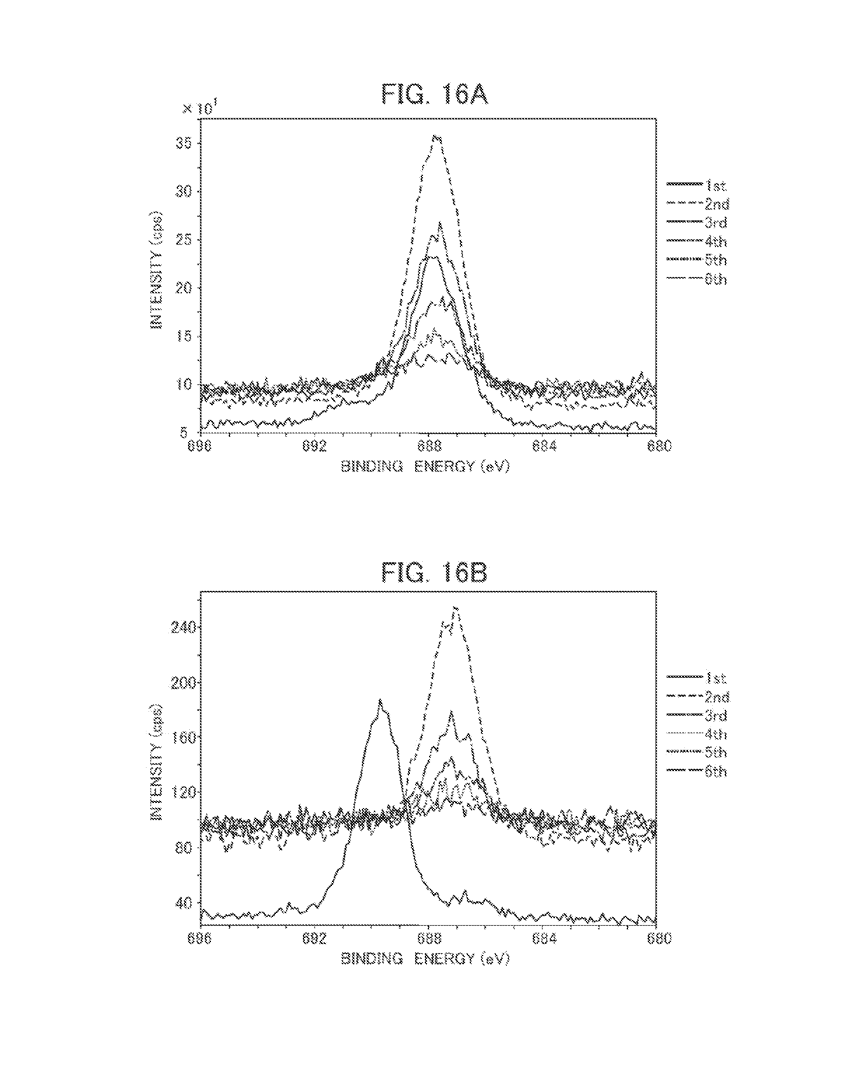

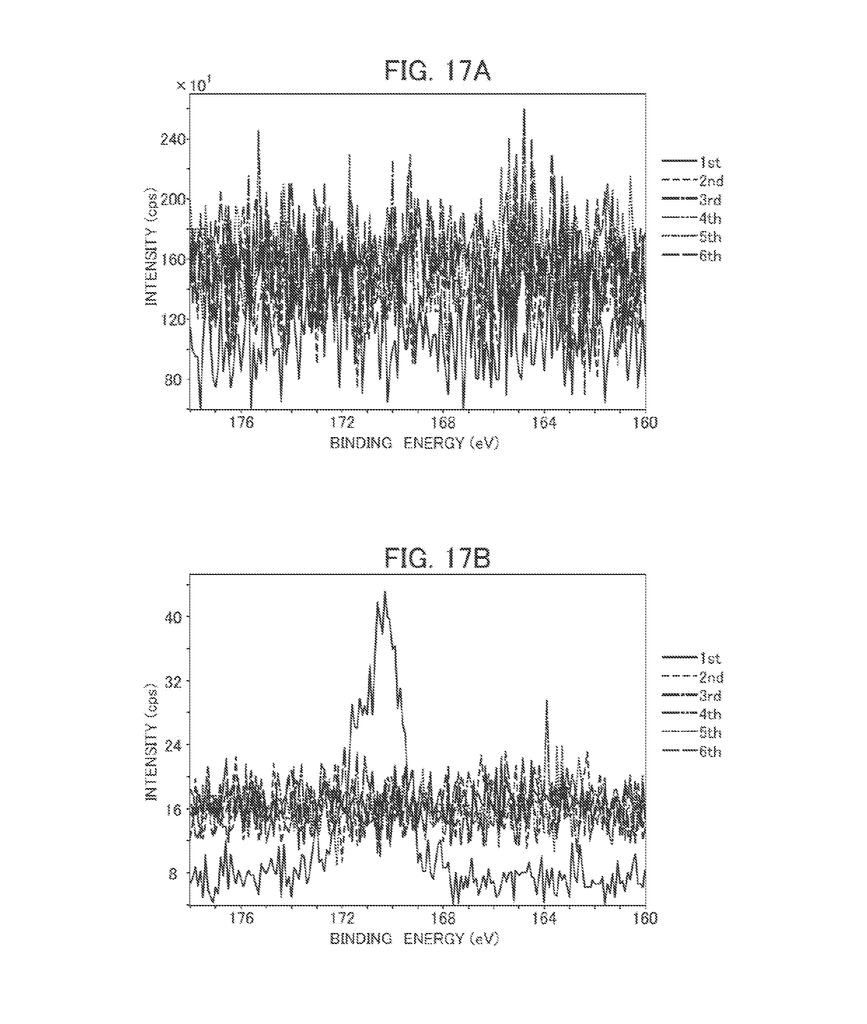

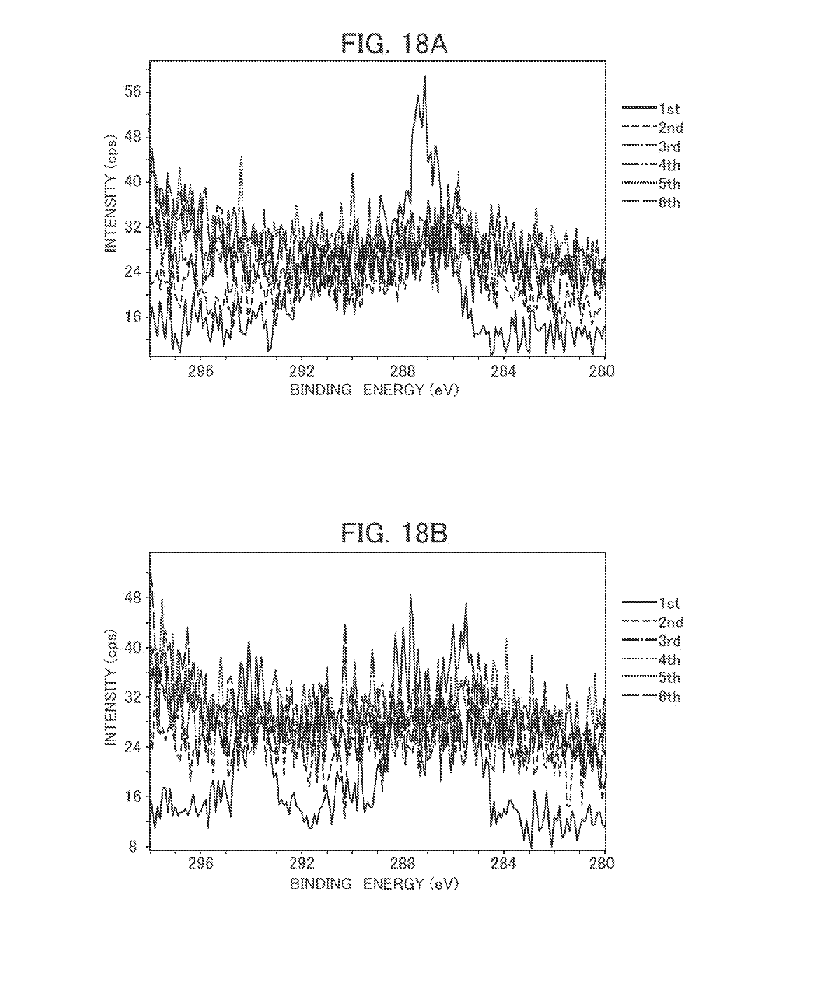

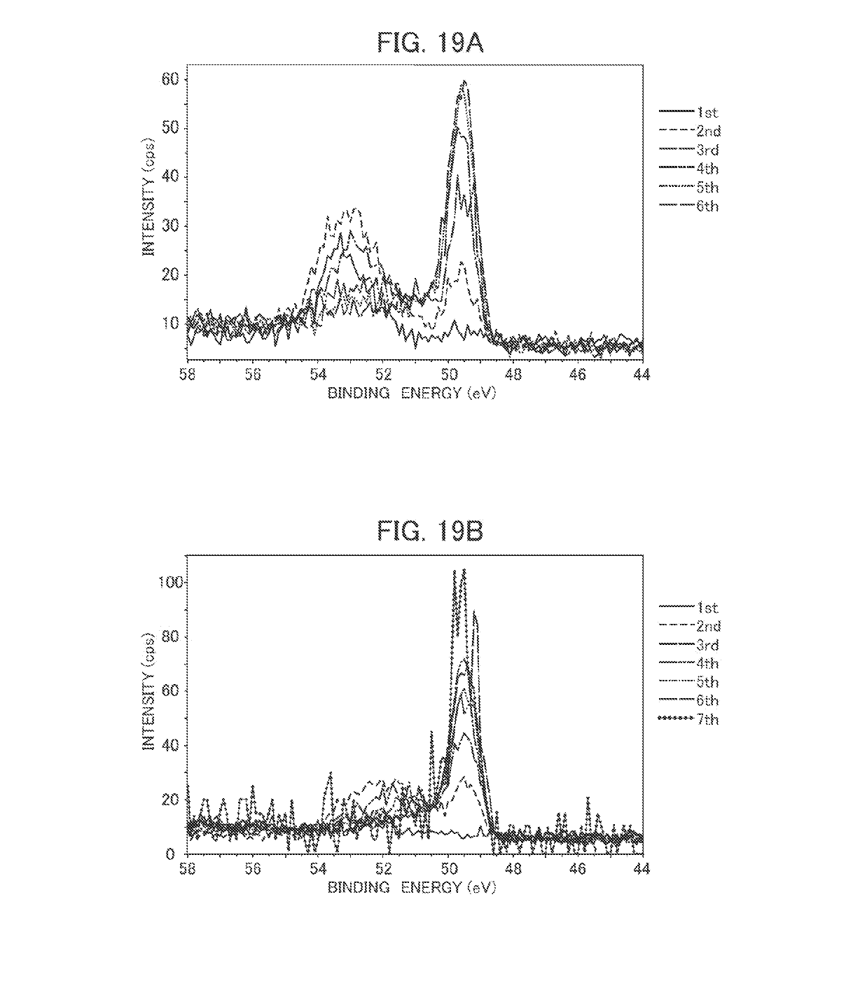

FIGS. 16A to 19B show XPS spectra. FIGS. 16A, 17A, 18A and 19A show XPS spectra of the Mg negative electrode after charging; and FIGS. 16B, 17B, 18B and 19B show analysis results of the Mg negative electrode after discharging. FIGS. 16A and 16B show XPS spectra of fluorine; FIGS. 17A and 17B show XPS spectra of sulfur; FIGS. 18A and 18B show XPS spectra of carbon; and FIGS. 19A and 19B show XPS spectra of magnesium.

As is clear from FIGS. 16A and 16B, a peak indicating fluorine (fluorocarbon) appeared in the surface of the negative electrode, and disappeared by milling, in both of FIGS. 16A and 16B; therefore, a coating containing fluorine with a certain thickness was formed on the surface of the Mg negative electrode, both after charging and discharging.

As is clear from FIGS. 17A and 17B, a peak indicating sulfate appeared only in the surface of the negative electrode of FIG. 17B, and disappeared by milling; therefore, a coating containing sulfate with a certain thickness was formed on the surface of the Mg negative electrode after charging.

As is clear from FIGS. 18A and 18B, a peak indicating flucrocarbon appeared only in the surface of the negative electrode of FIG. 18A, and disappeared by milling; therefore, a coating containing fluorocarbon with a certain thickness was formed on the surface of the Mg negative electrode after discharging.

As is clear from FIGS. 19A and 19B, a peak indicating Mg did not appear, but appeared by milling, in the surface of the negative electrode; therefore, a coating without Mg with a certain thickness was formed on the surface of the Mg negative electrode.

A broad peak derived from oxygen was confirmed only in the surface shown in FIG. 19A, and disappeared by depth-milling; therefore, a coating containing oxygen with a certain thickness was formed on the surface of the Mg negative electrode after discharging.

From the result above, it was confirmed that a passive-state coating derived from fluorine, through which magnesium ions can pass, was formed on the Mg surface after discharging; and a coating derived from fluorinated carbon and sulfur was formed on the coating after charging. This coating will dissolve into the electrolyte after discharging, and be formed again on the surface after charging, thereby enabling a reversible oxidation-reduction reaction to occur. It was confirmed that the ingredients of the coating were derived from, magnesium salt and cyclic acid anhydride.

### EXPLANATION OF REFERENCE NUMERALS

1 . . . magnesium secondary battery

11 . . . positive electrode

12 . . . negative electrode

12a, 12b, . . . SEI

13 . . . electrolyte

14 . . . container

What is claimed is:

1. An electrolyte comprising an organic solvent, magnesium salty and cyclic acid anhydride.

2. The electrolyte according to claim 1, wherein the cyclic acid anhydride is contained at a concentration at least equimolar to the magnesium salt.

3. The electrolyte according to claim 1, wherein the cyclic acid anhydride is contained at a molar concentration 1.0 to 3.0 times that of the magnesium salt.

4. A magnesium secondary battery comprising: a negative electrode including magnesium or magnesium alloy; and the electrolyte according to claim 1.

5. A magnesium secondary battery comprising: a negative electrode including magnesium or magnesium alloy; and the electrolyte according to claim 2.

6. A magnesium secondary battery comprising: a negative electrode including magnesium or magnesium alloy; and the electrolyte according to claim 3.
